(19) United States
(12) Patent Application Publication
(10) Pub. No.: US 2015/0253134 A1
(43) Pub. Date: Sep. 10, 2015

(54) DEPTH SAMPLING METHOD AND OPTICAL APPARATUS WITH DEPTH SAMPLING FUNCTION

(71) Applicant: LITE-ON TECHNOLOGY CORPORATION, Taipei (TW)

(72) Inventors: Chi-Hung Lin, Taipei (TW); Hua-De Lei, Taipei (TW)

(21) Appl. No.: 14/600,205

(22) Filed: Jan. 20, 2015

(30) Foreign Application Priority Data
Mar. 7, 2014 (CN) 201410082861.9

(51) Int. Cl. G01C 3/08

(52) U.S. Cl. CPC G01C 3/08

(57) ABSTRACT

A depth sampling method for an optical apparatus is provided. The optical apparatus includes an optical scanning module and an optical detecting module. The optical scanning module generates plural projection points along plural scan lines on a projection surface according to a sequence signal. The depth sampling method includes the following steps. Firstly, the plural scan lines are divided into at least two scan line groups. Then, plural first sampling points of a first scan line of one of the scan line groups are determined. Then, plural second sampling points of a second scan line of the scan line group are determined. There are relative shifts between the plural first sampling points and the plural second sampling points along a scan line direction.

This application claims the benefit of People's Republic of China Patent Application No. 201410082861.9, filed Mar. 7, 2014, the subject matter of which is incorporated herein by reference.

### FIELD OF THE INVENTION

The present invention relates to a depth sampling method and an optical apparatus with a depth sampling function, and more particularly to a depth sampling method and an optical apparatus for acquiring a depth sampling data while largely reducing the processed data amount.

### BACKGROUND OF THE INVENTION

Projectors are widely used in many circumstances. Recently, with increasing development of science and technology, a pico projector (also referred as a microdisplay) has been introduced into the market. The pico projector is designed to have small size and light weightiness. Generally, the pico projector is embedded into a portable electronic device, so that the pico projector may be directly utilized. By means of the pico projector, a corresponding projection image may be projected on a flat projection surface to be viewed by the user. In such way, the image to be shown may be projected in a maneuverable and real-time manner.

Generally, the pico projector uses light sources to emit light beams, and projects the light beams on the projection surface through a projection module. In a conventional pico projector, the projection module is for example an LCoS (liquid crystal on silicon) panel, a reflective LCD (liquid crystal display) panel, a DMD (digital Micro-mirror device) or a micro scanning mirror (i.e. according to a MEMS technology). Before the light beams are projected out through the projection module, the light beams are homogenized, focused or shaped by associated optical elements of the pico projector. After the light beams are homogenized, focused or shaped, the adjusted light beams are projected out. Generally, the light sources used in the pico projector are for example LED light sources or laser light sources.

FIG. 1 schematically illustrates the architecture of a conventional pico projector with a micro scanning mirror. As shown in FIG. 1, the pico projector 1 comprises a laser source 11 and a scanning mirror 12. In this embodiment, the pico projector with the micro scanning mirror may be referred as a scanning type pico projector. The laser source 11 is used for emitting three primary color beams. The projection points of the combined laser beam of three primary color beams are swept along a horizontal axis and a vertical axis (i.e. along a two-dimensional trajectory) by the scanning mirror 12. Consequently, an image is projected on a projection surface.

For example, by scanning one horizontal scan line of projection points from left to right and then changing the scan direction at another adjacent horizontal scan line (that is, the scanning directions of the start points of the odd-number and the even-number horizontal scan lines are opposite). Thus, scanning all of the horizontal scan lines sequentially from top to bottom, the projection image is produced according to human visual persistence.

In other word, the pixels corresponding to the projection points are sequentially projected out by the scanning type pico projector while each scan line is projected and producing the projection image. In contrast, the principle of producing the projection image by the pico projector with the LCoS panel is distinguished. After the light beam is transmitted through the LCoS panel, a planar projection image is directly projected out.

The scanning type pico projector may further comprise a depth detection function in order to be used in a gesture control mechanism or any other appropriate application. As shown in FIG. 1, a photo detector (PD) is installed in the pico projector 1. For example, the photo detector is an infrared light detector 13. The laser source 11 further comprises an infrared light source for emitting an infrared light. When the infrared light is projected on the projection surface through the scanning mirror 12, the intensity of the reflected infrared light is detected by the infrared light detector 13.

If the detected intensity of the reflected infrared light is stronger, the projection point has a smaller depth value. The smaller depth value indicates that the distance of the projection point from the pico projector 1 is smaller. On the other hand, if the detected intensity of the reflected infrared light is weaker, the projection point has a larger depth value. The larger depth value indicates that the distance of the projection point from the pico projector 1 is larger. That is, by detecting the intensity of the reflected infrared light from each corresponding projection point, the information about the corresponding depth value of the projection surface is obtained. After the information about the depth values is processed, the pico projector 1 can realize the presence or the motion of the projection surface (or an object) in order to provide gesture control or virtual control.

Generally, the infrared detecting technologies applied to different imaging mechanisms (e.g. the sequential projection points imaging mechanism or the whole image projecting mechanism) are different. For example, the LCoS pico projector uses a CMOS or CCD to detect the intensity of the reflected infrared light of the whole image and then uses a processor to calculate and analyze the infrared light intensities of respective regions.

As mentioned above, the pixels corresponding to the projection points are sequentially projected out by the scanning type pico projector while each scan line is projected. In other word, the scan line is composed of plural projection points. Consequently, after the detecting time points corresponding to the infrared light intensities are realized by the infrared light detector 13, the positions and the depth values of the corresponding projection points can be obtained without the need of further calculation or analysis.

However, for acquiring the depth values of the whole projection surface, all projection points are detected by the infrared light detector 13. Since all projection points are detected by the infrared light detector 13, the number of the sampling points is very huge. That is, the data amount to be processed is largely increased. Under this circumstance, a large storage capacity and a lengthy computation time are necessary. Moreover, due to the hardware limitations, the response speed of the infrared light detector fails to meet the requirement of the sequential projection point detection.

Therefore, there is a need of providing a depth sampling method and an optical apparatus with a depth sampling function for acquiring a depth sampling data while largely reducing the processed data amount.

### SUMMARY OF THE INVENTION

The present invention provides a depth sampling method and an optical apparatus with a depth sampling function in order to largely reduce the processed data amount and avoid the influence of the slow response speed of the detecting element.

An embodiment of the present invention provides a depth sampling method for an optical apparatus. The optical apparatus includes an optical scanning module and an optical detecting module. The optical scanning module generates plural projection points along plural scan lines on a projection surface according to a sequence signal. The depth sampling method includes the following steps. Firstly, the plural scan lines are divided into at least two scan line groups. Then, plural first sampling points of a first scan line of one of the scan line groups are determined. Then, plural second sampling points of a second scan line of the scan line group are determined. There are relative shifts between the plural first sampling points and the plural second sampling points along a scan line direction.

An embodiment of the present invention provides an optical apparatus with a depth sampling function. The optical apparatus includes an optical scanning module, a controlling module and an optical detecting module.

The optical scanning module generates plural projection points along plural scan lines on a projection surface according to a sequence signal. The controlling module may divide the plural scan lines into at least two scan line groups, determine plural first sampling points of a first scan line of one of the scan line groups and determine plural second sampling points of a second scan line of the scan line group. There are relative shifts between the plural first sampling points and the plural second sampling points along a scan line direction. The optical detecting module detects the plural first sampling points and the plural second sampling points, thereby obtaining plural depth values.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) schematically illustrates the architecture of a conventional pico projector with a micro scanning mirror;

FIG. 2 is a schematic functional block diagram illustrating the architecture of an optical apparatus with a depth sampling function according to an embodiment of the present invention;

FIG. 3 schematically illustrates the relationship between the timing waveform diagram of a horizontal synchronizing signal (H-sync) and an enabling signal (DE) and the sampling diagram of the horizontal scan line on the projection surface;

FIG. 4 schematically illustrates the concept of a depth sampling method according to an embodiment of the present invention;

FIG. 5 schematically illustrates the relationships between the positions of the depth values of a depth sampling line and the corresponding sampling points; and

FIG. 6 is a flowchart illustrating a depth sampling method according to an embodiment of the present invention.

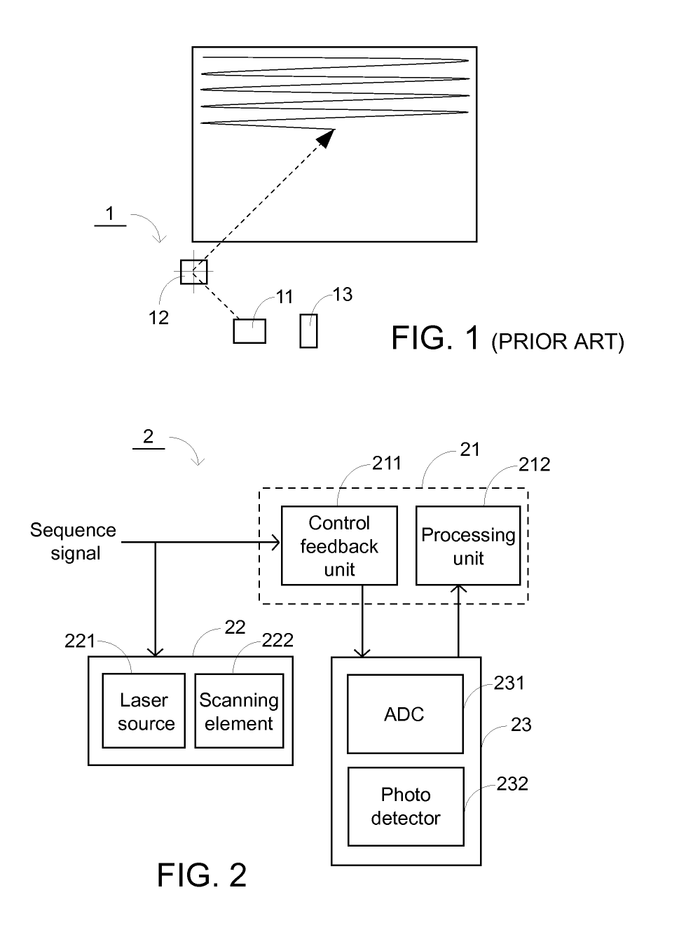

### DETAILED DESCRIPTION OF PREFERRED EMBODIMENTS

FIG. 2 is a schematic functional block diagram illustrating the architecture of an optical apparatus with a depth sampling function according to an embodiment of the present invention. As shown in FIG. 2, the optical apparatus 2 comprises an optical scanning module 22, an optical detecting module 23 and a controlling module 21. The optical scanning module 22 comprises a laser source 221 and a scanning element 222. The laser source 221 is used for emitting a detecting light. The detecting light is projected on a projecting surface along a two-dimensional scanning trajectory by the scanning element 222.

The optical detecting module 23 comprises a photo detector 232 and an analog-to-digital converter (ADC) 231. The controlling module 21 comprises a control feedback unit 211 and a processing unit 212. In an embodiment, the detecting light emitted by the laser source 221 is an infrared light (IR). The photo detector 232 is used for detecting the intensity of the reflected detecting light (e.g. the reflected infrared light). The intensity of the reflected detecting light is an analog signal. After the format conversion by the analog-to-digital converter 231, the analog signal is converted into a corresponding depth value. The depth value is further processed by the processing unit 212.

In this embodiment, the optical apparatus 2 is a scanning type pico projector. While each scan line is projected, plural projection points are sequentially projected out by the optical scanning module 22. In other words, the scan line is composed of plural projection points. It is noted that the depth sampling method is not only applied to the scanning type pico projector.

Moreover, the depth sampling method may be applied to any other appropriate optical apparatus that generates the projection points along the two-dimensional scanning trajectory.

During the scanning process, the optical scanning module 22 projects the detecting light according to a sequence signal. Moreover, the operations of the optical detecting module 23 are controlled by the control feedback unit 211 according to the sequence signal. In an embodiment, the sequence signal is an image sequence signal. The laser source 221 is used for emitting three primary color beams. According to the image sequence signal, an image is projected on the projection surface.

In particular, the optical sampling method of the photo detector 232 is determined by the control feedback unit 211 according to the sequence signal. Consequently, the depth values of the projection surface can be acquired by using the least number of sampling points. Since it is not necessary to perform the detection for each projection point, the amount of data to be processed is reduced and the influence of the slow response speed can be avoided.

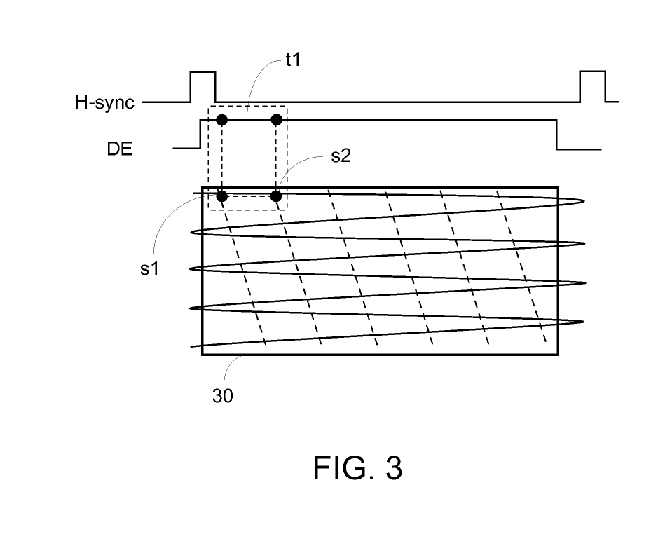

FIG. 3 schematically illustrates the relationship between the timing waveform diagram of a horizontal synchronizing signal (H-sync) and an enabling signal (DE) and the sampling diagram of the horizontal scan line on the projection surface. As shown in FIG. 3, a pulse of the horizontal synchronizing signal (H-sync) is correlated with the start point of each horizontal scan line on the projection surface 30. For clarification and brevity, only one horizontal synchronizing signal of the corresponding horizontal scan line is shown in the drawing. The other horizontal scan lines on the projection surface 30 are controlled by the similar horizontal synchronizing signals.

The high-level part of the enabling signal denotes the effective detection range corresponding to the horizontal scan line containing the projection points. In other words, if the enabling signal is switched to the high-level state, the optical scanning module 22 starts to generate the detecting light according to the sequence signal. According to the sequence signal, the optical scanning module 22 generates the projection points along the scan lines. That is, during the process of generating the projection points of each horizontal scan line, the control feedback unit 211 can realize the generated time points and the positions of the projection points according to the sequence signal.

In accordance with the present invention, after the sampling points of the projection points on the projection surface 30 or all scan lines are determined, the determined sampling points (e.g. s1, s2, . . . ) are subject to optical detection. In other words, if the generated time points and the positions of the projection points are known, the projection points to be sampled or detected are firstly determined according to the selections or settings of the time points and then these sampling points (i.e. the corresponding projection points) are subject to optical detection. Then, the depth values are obtained by detecting the intensity of the corresponding sampling points. In accordance with the depth sampling method of the present invention, the scan lines are divided into at least two groups. In the same group, there is a sampling time interval t1 (or a specified number of projection points) between every two adjacent sampling points of the same scan line. Moreover, in the same group, there is a relative shift between the sampling points of the adjacent scan lines. Consequently, the depth values of the projection surface can be acquired by using the least number of sampling points.

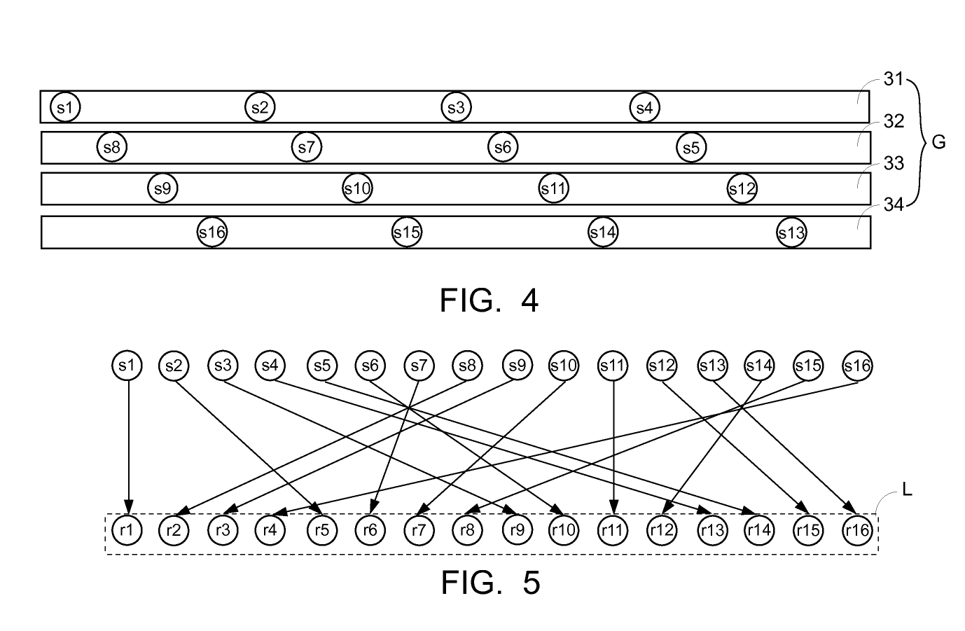

FIG. 4 schematically illustrates the concept of a depth sampling method according to an embodiment of the present invention. While the detecting light is swept across the scan line to generate the projection points, the sampling process is also performed. In addition, the optical detection is performed at the sampling time point. In this embodiment, the sampling process is controlled by the control feedback unit 211. The controlling module 21 may define a projection resolution of the projection points on the projection surface 30 according to the sequence signal and the distribution of the projection points on the projection surface. In particular, the projection resolution comprises a first horizontal resolution and a first vertical resolution. The first horizontal resolution is related to the number of the projection points of each scan line. The first vertical resolution is related to the number of the scan lines. In other words, the first horizontal resolution is the number of the projection points in the horizontal direction, and the first vertical resolution is the number of the projection points in the vertical direction.

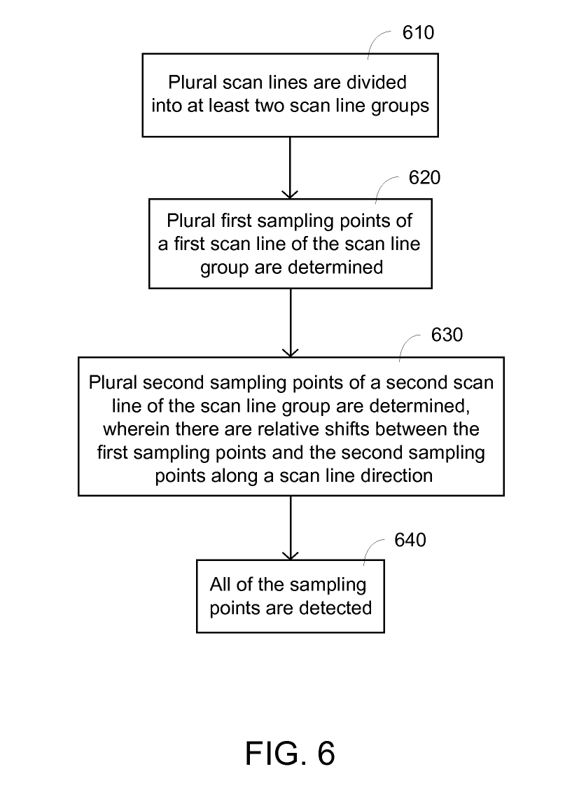

FIG. 6 is a flowchart illustrating a depth sampling method according to an embodiment of the present invention. Firstly, in the step 610, plural scan lines are divided into at least two scan line groups by the controlling module 21. Then, in the step 620, plural first sampling points of a first scan line of the scan line group are determined by the controlling module 21. Then, in the step 630, plural second sampling points of a second scan line of the scan line group are determined by the controlling module 21, wherein there are relative shifts between the first sampling points and the second sampling points along a scan line direction. Then, in the step 640, all of the sampling points are detected by the optical detecting module 23, so that plural depth values corresponding to the sampling points are obtained. In this embodiment, the first scan line and the second scan line belong to the same scan line group, and there are plural projection points between every two adjacent sampling points of the same scan line.

Moreover, the depth sampling method further comprises a step of determining a sampling time interval. According to the sampling time interval, the spacing interval between the adjacent sampling points of the same scan line is determined by the controlling module 21. Moreover, the plural projection points between every two adjacent sampling points of the same scan line are correlated with the sampling time interval.

In case that the projection resolution is 1024×720, there are 720 scan lines on the projection surface 30, wherein each scan line contains 1024 projection points. In the step 610, the plural scan lines are divided into at least two scan line groups by the controlling module 21 according to the projection resolution. For example, the 720 scan lines are divided into 10 scan line groups, wherein each scan line group contains 72 scan lines.

In FIG. 4, a scan line group G is shown. In this embodiment, the scan line group G comprises four scan lines 31˜34. The projection points of the scan lines 31 and 33 are swept from left to right, and the projection points of the scan lines 32 and 34 are swept from right to left. That is, after the projection points of the scan line 31 are swept from left to right, the projection points of the scan line 32 are swept from right to left.

Please refer to FIGS. 4 and 6. In the step 620, plural first sampling points s1, s2, s3 and s4 of the first scan line 31 of the scan line group G are determined by the controlling module 21. Then, in the step 630, plural second sampling points s5, s6, s7 and s8 of the second scan line 32 of the scan line group G are determined by the controlling module 21.

Moreover, there are relative shifts between the first sampling points s1, s2, s3 and s4 and the second sampling points s5, s6, s7 and s8 along the scan line direction.

Similarly, the sampling points of the scan lines 33 and 34 of the scan line group G can be determined by the above procedures. For example, plural third sampling points s9, s10, s11 and s12 of the third scan line 33 of the scan line group G and plural fourth sampling points s13, s14, s15 and s16 of the fourth scan line 34 of the scan line group G are determined. In this embodiment, the sampling points of these scan lines of the same scan line group are staggered along the scan line direction. For example, there are relative shifts between the sampling points 51, S8, S9 and S16 of the scan lines 31˜34 of the scan line group G along the scan line direction from the left side. Moreover, the sampling points S1, S8, S9 and S16 are obliquely arranged and staggered. In other words, all sampling points of the same scan line group are not aligned with each other along the scan line direction (e.g. from the left side).

For example, in the step 620, the determined sampling points s1, s2, s3 and s4 of the first scan line 31 are the 20^{th}, the 320^{th}, the 640^{th} and the 960^{th} projection points of the first scan line 31 from the left side. In the step 630, the determined sampling points s8, s7, s6 and s5 of the second scan line 32 are the 30^{th}, the 330^{th}, the 650^{th} and the 970^{th} projection points of the second scan line 32 from the left side. That is, the sampling points of the second scan line 32 are shifted to the right side by ten projection points with respect to the corresponding sampling points of the first scan line 31. Since the sampling points s1, s2, s3 and s4 of the first scan line 31 and the sampling points s8, s7, s6 and s5 of the second scan line 32 are the 20^{th}, the 320^{th}, the 640^{th}, the 960^{th}, the 30^{th}, the 330^{th}, the 650^{th} and the 970^{th} projection points along the scan line direction from the left side, and these sampling points are not aligned with each other.

It is noted that the generated time points and the positions of the projection points on the projection surface 30 may be inferred according to the sequence signal. Consequently, after the projection points corresponding to all sampling points are determined, these projection points are simultaneously generated, detected and processed according to the sequence signal.

After the projection points on the projection surface 30 is sequentially and completely projected out, it means that the projection points of all scan lines have been generated and all sampling points have been detected. Consequently, the depth values corresponding to the sampling points are obtained. According to the positions of the sampling points and the corresponding depth values, a depth sampling data corresponding to the projection surface 30 is obtained. The depth sampling data contains the plural depth values, a second horizontal resolution and a second vertical resolution. The second horizontal resolution is related to the number of the depth values of the depth sampling data in the horizontal direction, and the second vertical resolution is related to the number of the depth values of the depth sampling data in the vertical direction. In other words, the second horizontal resolution and the second vertical resolution of the depth sampling data are compressed when compared with the first horizontal resolution and the first vertical resolution of the projection points on the projection surface 30.

In an embodiment, the scan lines of each scan line group are compressed as a corresponding depth sampling line. Moreover, each depth sampling line contains the depth values of all sampling points of the corresponding scan line group. That is, the number of the depth values of each depth sampling line is equal to the number of the sampling points of the corresponding scan line group. As shown in FIG. 4, the scan line group G comprises four scan lines 31˜34 and sixteen sampling points s1˜s16. After the depth values of these sampling points s1˜s16 are acquired, the processing unit 212 combines the corresponding depth values as the corresponding depth sampling line according to the positions of the sampling points s1˜s16. As shown in FIG. 5, the depth sampling line contains sixteen depth values r1˜r16.

FIG. 5 schematically illustrates the relationships between the positions of the depth values r1˜r16 of a depth sampling line L and the corresponding sampling points s1˜s16. Please refer to FIGS. 4 and 5. In this embodiment, the sequence of the depth values r1˜r16 of the depth sampling line L is corresponding to the sequence of the positions of the sampling points s1˜s16 along the scan line direction from the left side. For example, the first depth value r1 of the depth sampling line L is related to the sampling point s1 of the four scan lines 31˜34 of the scan line group G, the second depth value r2 of the depth sampling line L is related to the sampling point s8 of the four scan lines 31˜34 of the scan line group G, the third depth value r3 of the depth sampling line L is related to the sampling point s9 of the four scan lines 31˜34 of the scan line group G, and the fourth depth value r4 of the depth sampling line L is related to the sampling point s16 of the four scan lines 31˜34 of the scan line group G. The rest may be deduced by analogy. After this scan line group is processed, the processing unit 212 may process the next scan line group in order to obtain the next depth sampling line. After these depth sampling lines are combined together, the depth sampling data is obtained.

As mentioned above, the four scan lines 31˜34 of the scan line group G on the projection surface 30 are compressed as the corresponding depth sampling line L. The horizontal resolution of the depth sampling data is 16, which is equal to the number of the depth values r1˜r16. However, the vertical resolution of the depth sampling data is only one fourth of the vertical resolution of the projection points on the projection surface 30.

In other words, the second vertical resolution of the depth sampling data is equal to the number of the scan line groups or equal to the quotient of the first vertical resolution divided by a specified number. Moreover, the second horizontal resolution of the depth sampling data is equal to the number of all sampling points of the corresponding scan line group.

From the above descriptions, the present invention provides a depth sampling method and an optical apparatus with a depth sampling function. By the depth sampling method of the present invention, the amount of data to be processed is reduced and the influence of the slow response speed of the detecting element can be avoided. Moreover, after the optical detections on the sampling points are performed, the depth sampling data is obtained. The depth sampling data has reduced resolution. That is, the sampling points can be used in gesture control or virtual control.

Consequently, the depth sampling method of the present invention can reduce the processed data amount while eliminating the drawbacks of the conventional pico projector.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A depth sampling method for an optical apparatus, the optical apparatus comprising an optical scanning module and an optical detecting module, the optical scanning module generating plural projection points along plural scan lines on a projection surface according to a sequence signal, the depth sampling method comprising steps of:
dividing the plural scan lines into at least two scan line groups;
determining plural first sampling points of a first scan line of one of the scan line groups; and
determining plural second sampling points of a second scan line of the scan line group, wherein there are relative shifts between the plural first sampling points and the plural second sampling points along a scan line direction.

2. The depth sampling method as claimed in claim 1, wherein the plural projection points are projected on the projection surface along a two-dimensional scanning trajectory by the optical scanning module.

3. The depth sampling method as claimed in claim 1, wherein after the plural first sampling points and the plural second sampling points are detected by the optical detecting module, plural depth values corresponding to the plural first sampling points and the plural second sampling points are obtained.

4. The depth sampling method as claimed in claim 3, further comprising a step of obtaining a depth sampling data corresponding to the projection surface according to the plural depth values, wherein the depth sampling data contains plural depth sampling lines, wherein the number of the depth values of each depth sampling line is equal to the number of the sampling points of the corresponding scan line group.

5. The depth sampling method as claimed in claim 1, wherein there are a specified number of projection points between every two adjacent sampling points of the same scan line.

6. The depth sampling method as claimed in claim 1, wherein the plural first sampling points and the plural second sampling points are staggered along the scan line direction.

7. An optical apparatus with a depth sampling function, the optical apparatus comprising:
an optical scanning module generating plural projection points along plural scan lines on a projection surface according to a sequence signal;
a controlling module for dividing the plural scan lines into at least two scan line groups, determining plural first sampling points of a first scan line of one of the scan line groups, and determining plural second sampling points of a second scan line of the scan line group, wherein there are relative shifts between the plural first sampling points and the plural second sampling points along a scan line direction; and
an optical detecting module for detecting the plural first sampling points and the plural second sampling points, thereby obtaining plural depth values.

8. The optical apparatus as claimed in claim 7, wherein the optical scanning module comprises:
a laser source for generating a detecting light; and
a scanning element for projecting the detecting light on the projection surface along a two-dimensional scanning trajectory.

9. The optical apparatus as claimed in claim 7, wherein the controlling module further obtains a depth sampling data corresponding to the projection surface according to the plural depth values, wherein the depth sampling data contains plural depth sampling lines, wherein the number of the depth values of each depth sampling line is equal to the number of the sampling points of the corresponding scan line group.

10. The optical apparatus as claimed in claim 7, wherein the plural first sampling points and the plural second sampling points are staggered along the scan line direction.
